(19) United States
(12) Patent Application Publication
(10) Pub. No.: US 2015/0146235 A1
(43) Pub. Date: May 28, 2015

(54) IMAGE FORMING APPARATUS, METHOD FOR CONTROLLING THE SAME, AND STORAGE MEDIUM

(71) Applicant: CANON KABUSHIKI KAISHA, Tokyo (JP)

(72) Inventor: Hiroshi Sekine, Kawasaki-shi (JP)

(21) Appl. No.: 14/551,836

(22) Filed: Nov. 24, 2014

(30) Foreign Application Priority Data
Nov. 26, 2013 (JP) 2013-244123

(51) Int. Cl. G06F 3/12; G06K 15/00

(52) U.S. Cl. CPC G06F 3/123; G06K 15/4055
USPC 358/1.14

(57) ABSTRACT

An image forming apparatus operable at least in a first power state and a second power state includes a control unit configured to update firmware, and a power source control unit configured to stop supplying power to the control unit in the first power state if a power source switch is operated by a user, and stop supplying power to the control unit in the second power state if the power source control unit receives a request sent from the control unit for turning off a power source, where the control unit performs control so that the image forming apparatus transitions to the second power state when the control unit updates the firmware.

### BACKGROUND

1. Field

Aspects of the present invention generally relate to a technique for preventing a power source of a control unit for updating firmware from being turned off while firmware of an image forming apparatus is being updated.

2. Description of the Related Art

In an image forming apparatus, firmware is updated to extend, change, and upgrade functions of the image forming apparatus. In recent years, a method has prevailed that updates firmware by receiving firmware from an external apparatus connected via a network (refer to Japanese Patent Application Laid-Open No. 2007-310690).

In addition, some low-end image forming apparatuses shut off power supplied to a control unit for controlling operation of an image forming apparatus without executing any processing for ending an application when a user presses a power source switch. Pressing the power source switch while the firmware is being updated in the image forming apparatus interrupts the update of the firmware. This sometimes cannot activate the image forming apparatus.

### SUMMARY

Aspects of the present invention are generally directed to an image forming apparatus capable of preventing a power source of a control unit for updating firmware from being turned off while the firmware is being updated.

According to an aspect of the present invention, an image forming apparatus operating at least in a first power state and a second power state includes a control unit configured to update firmware and a power source control unit configured to stop supplying power to the control unit in the first power state on condition that a power source switch is operated by a user, and stop supplying power to the control unit in the second power state on condition that the power source control unit receives a request from the control unit for turning off a power source. The control unit performs control so that the image forming apparatus transitions to the second power state when the control unit updates the firmware.

Further features of the present disclosure will become apparent from the following description of exemplary embodiments with reference to the attached drawings.

### BRIEF DESCRIPTION OF THE DRAWINGS

FIG. 1 is a schematic diagram of a printing system including a client PC and an image forming apparatus.

FIG. 2 is a block diagram of hardware of the image forming apparatus.

FIG. 3 is a block diagram illustrating details of hardware of a control unit.

FIG. 4 is a block diagram illustrating details of hardware of a printer control unit.

FIG. 5 is a power source circuit diagram of the image forming apparatus.

FIG. 6 illustrates a state transition diagram of the image forming apparatus.

FIGS. 7A, 7B, 7C, and 7D illustrate the image forming apparatus in different power states.

FIG. 8 is a flow chart illustrating processing executed by the control unit 201 in updating firmware.

FIG. 9 is a flow chart illustrating processing executed by the CPU 301 in a sleep state where supply of power to a printer 204 is stopped or in a firmware update state.

FIG. 10 is a flow chart illustrating processing executed by the power source control unit.

### DESCRIPTION OF THE EMBODIMENTS

Various exemplary embodiments will be described in detail below with reference to the drawings.

A first exemplary embodiment is described below with reference to attached drawings.

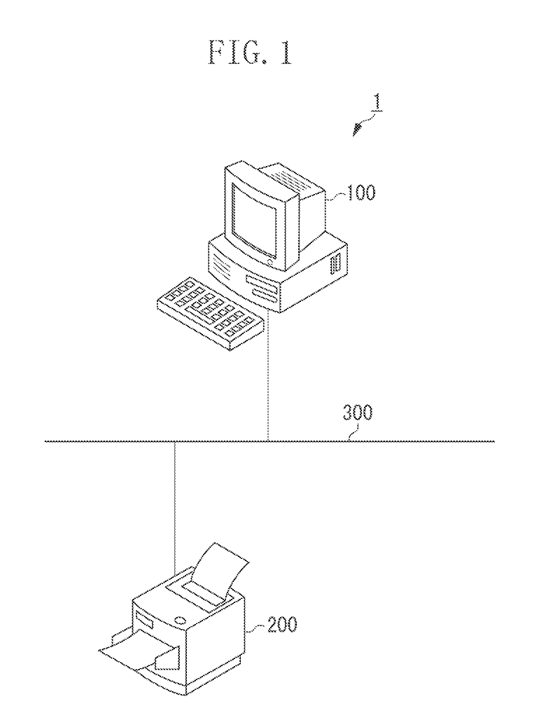

FIG. 1 is a schematic diagram illustrating an overall configuration of a printing system including an image forming apparatus according to the first exemplary embodiment.

A printing system 1 includes a client personal computer (PC) 100 and an image forming apparatus 200. In the printing system 1, the client PC 100 and the image forming apparatus 200 communicate with each other via a network 300. The network 300 may be a wire or a wireless network. The client PC 100 and the image forming apparatus 200 may be connected with each other via a local interface such as a universal serial bus (USB) instead of the network 300.

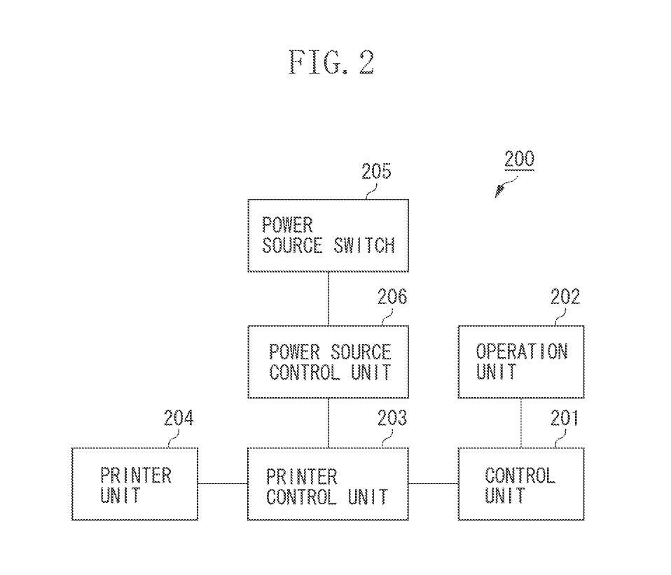

FIG. 2 is a block diagram of hardware of the image forming apparatus 200.

The image forming apparatus 200 includes a control unit 201, an operation unit 202, a printer control unit 203, a printer unit 204, a power source switch 205, and a power source control unit 206. The control unit 201 controls the operation of the units in the image forming apparatus 200. The operation unit 202 includes hard keys for the user performing various operations and a light-emitting diode (LED) and the like for displaying the status of the image forming apparatus 200. The operation unit 202 may include a display panel for displaying images and texts. The printer control unit 203 controls the operation of the printer unit 204. The printer unit 204 includes a fixing device for fixing a toner image transferred to a photosensitive member or a sheet on which the toner image is formed. The power source switch 205 is the one that is operated by the user when the image forming apparatus 200 is turned off, and when the image forming apparatus 200 in an off state is turned on. When the power source switch 205 is operated by the user, a logic value of a signal input to the power source control unit 206 changes. The power source control unit 206 monitors a change in the logic value of the input signal to determine whether the power source switch 205 is operated. The power source switch 205 may be a toggle switch or a seesaw switch. The power source control unit 206 controls power supplied to the image forming apparatus 200. Details of the power source control unit 206 are described below.

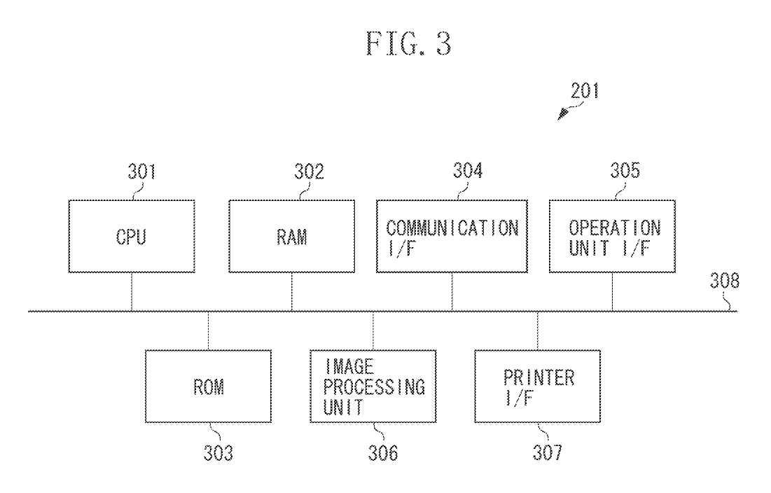

FIG. 3 is a block diagram of hardware of the control unit 201.

The control unit 201 includes a central processing unit (CPU) 301, a random access memory (RAM) 302, a read only memory (ROM) 303, a communication interface (I/F) 304, an operation unit I/F 305, an image processing unit 306, and a printer I/F 307. The CPU 301, the RAM 302, the ROM 303, the communication I/F 304, the operation unit I/F 305, the image processing unit 306, and the printer I/F 307 are communicably connected with one another via a system bus 308.

The CPU 301 controls access to various devices connected to the CPU 301 based on control programs stored in the ROM 303. The RAM 302 is a system work memory for operating the CPU 301. The RAM 302 temporarily stores the image data subjected to image processing by the image processing unit 306. The communication I/F 304 is an interface for connecting the client PC 100 to the system bus 308. The communication I/F 304 is a USB interface or a local area network (LAN) interface, for example. The operation unit I/F 305 is an interface for connecting the operation unit 202 to the system bus 308. The image processing unit 306 performs image processing on the input image data. More specifically, the image processing unit 306 reads the image data stored in the RAM 302 and performs image processing such as enlargement processing, reduction processing, and color adjustment processing, on the read image data. The image data subjected to image processing by the image processing unit 306 is output to the printer control unit 203 via the printer I/F 307.

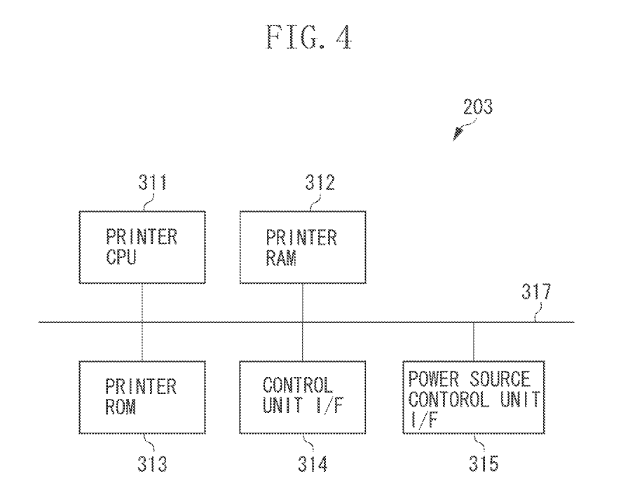

FIG. 4 is a block diagram of hardware of the printer control unit 203.

The printer control unit 203 includes a printer CPU 311, a printer RAM 312, a printer ROM 313, a control unit I/F 314, and a power source control unit I/F 315. The printer CPU 311, the printer RAM 312, the printer ROM 313, the control unit I/F 314, and the power source control unit I/F 315 are communicably connected with one another via a system bus 317.

The printer CPU 311 controls the operation of the printer unit 204 based on control programs stored in the printer ROM 313. The printer RAM 312 is a system work memory for operating the CPU 311. In the present exemplary embodiment, the printer RAM 312 stores information indicating that the power source switch 205 is pressed in a specific state, such as a power on state. The control unit I/F 314 is an interface for communicating with the control unit 201. The power source control unit I/F 315 is provided to notify the power source control unit 206 that the power source switch 205 that can be operated by the user is pressed.

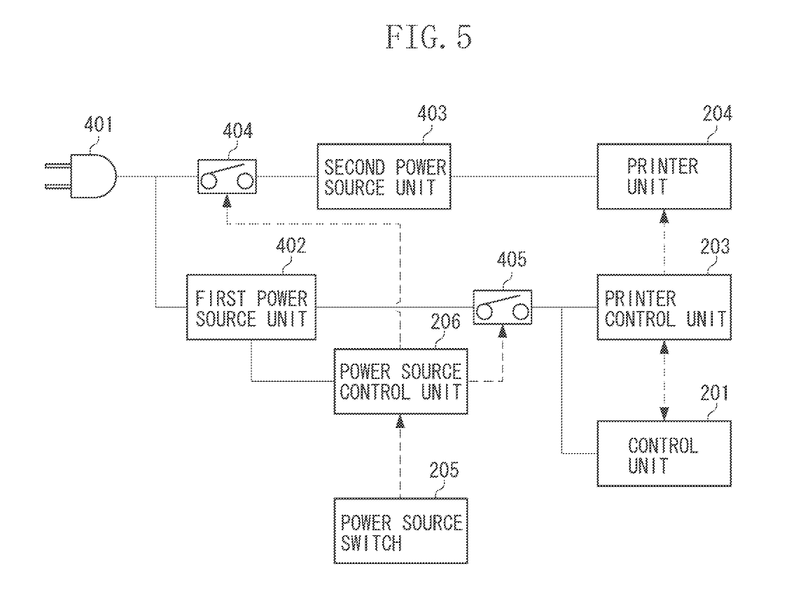

FIG. 5 is a power source circuit diagram of the image forming apparatus.

A solid line drawn in FIG. 5 indicates a power source line and a broken line indicates a signal line.

An alternating current (AC) power source is supplied to the image forming apparatus 200 through an electric plug 401. First and second power source units 402 and 403 convert AC power supplied through the electric plug 401 into direct current (DC) power. The first power source unit 402 generates 3.3-volt DC power, for example. A voltage generated by the first power source unit 402 is supplied to the control unit 201, the printer control unit 203, the operation unit 202, and the power source control unit 206. The second power source unit 403 generates 12.0-volt DC power, for example. A voltage generated by the second power source unit 403 is supplied to the printer unit 204. A relay 404 is arranged between the electric plug 401 and the second power source unit 403. The state of the relay 404 is controlled by the power source control unit 206. A relay 405 is arranged between the first power source unit 402, and the printer control unit 203 and the control unit 201. The state of the relay 405 is controlled by the power source control unit 206.

### (State Transition of the Image Forming Apparatus)

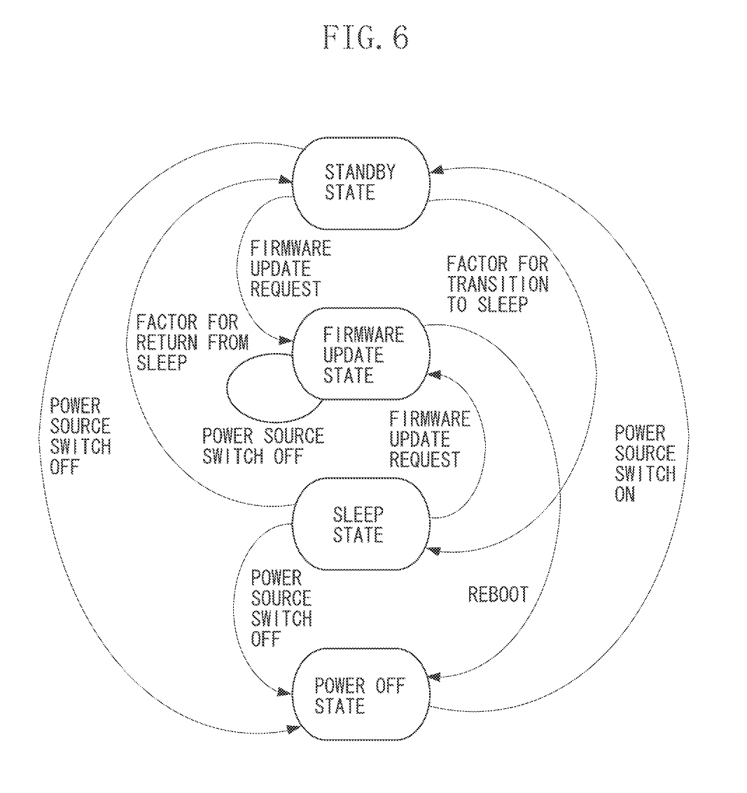

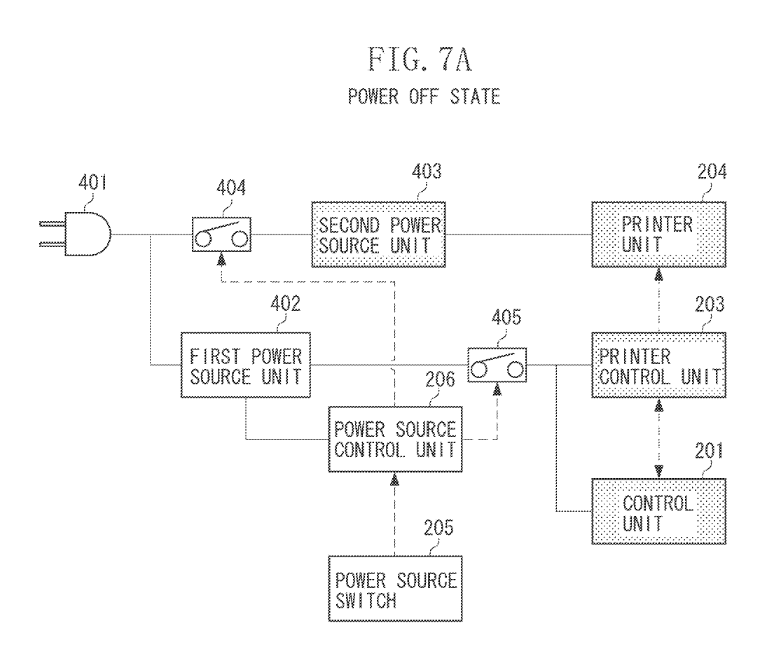

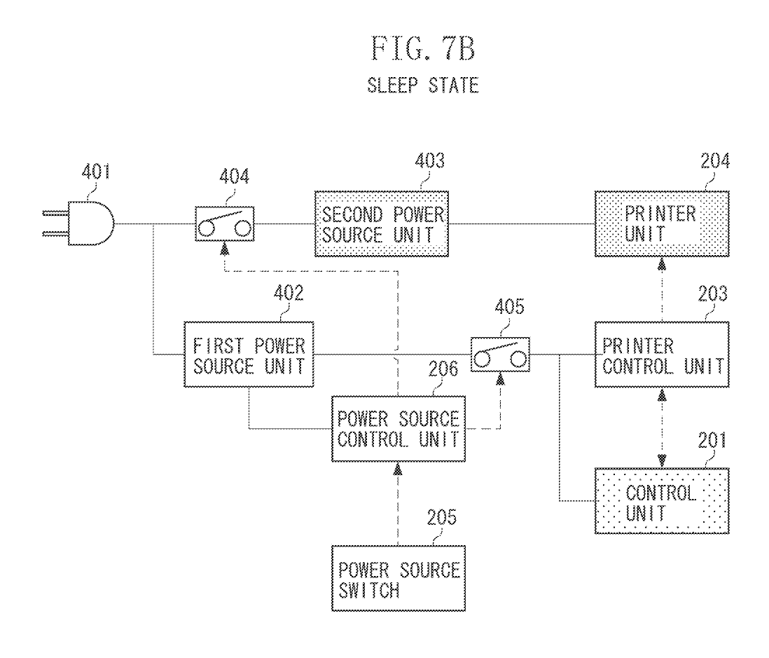

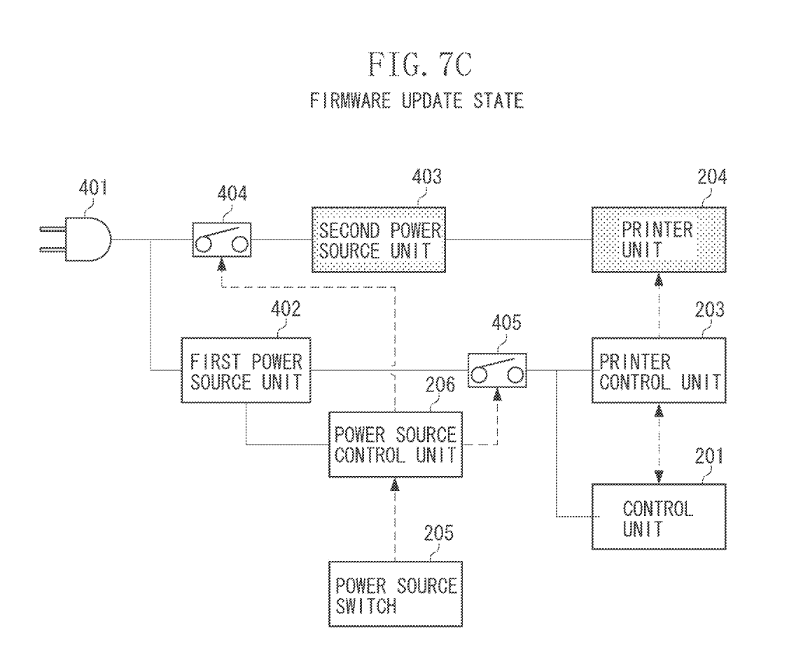

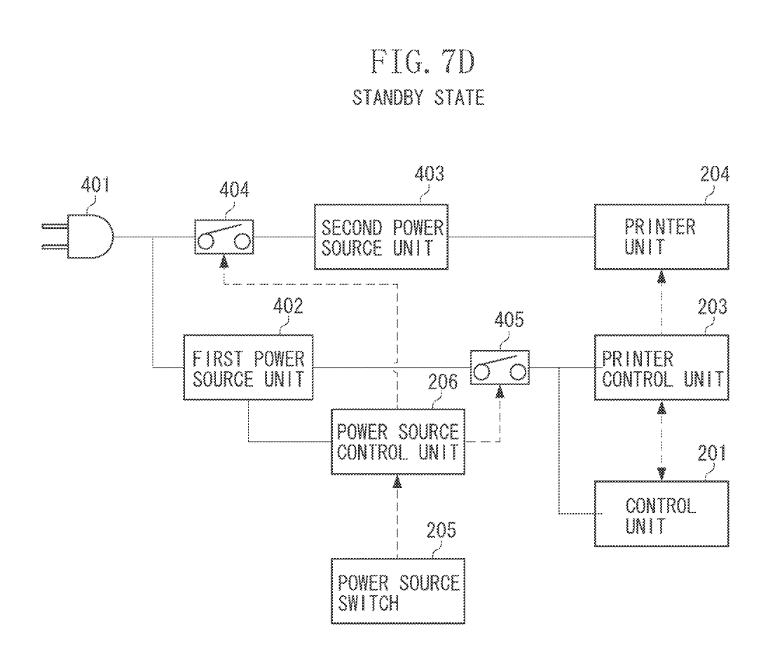

FIG. 6 illustrates a state transition diagram of the image forming apparatus 200. FIG. 7 illustrates the image forming apparatus 200 in different power states.

As illustrated in FIG. 6 and FIGS. 7A to 7D, the image forming apparatus 200 transitions to any of a power off state, a sleep state, a firmware update state, and a standby state. The image forming apparatus 200 may transitions to a state other than the above mentioned states (for example, a state transitioning from the above sleep state to a deep sleep state where the supply of a clock to the CPU 301 is stopped). In the sleep state and the firmware update state, the supply of power to the CPU 301 updating the firmware is maintained.

As illustrated in FIG. 7A, the relays 404 and 405 are tuned off in the power off state. In this state, power is supplied from the first power source unit 402 to the power source control unit 206, but not supplied to the control unit 201 and the printer control unit 203. In addition, in the power off state, power is not supplied from the second power source unit 403 to the printer unit 204.

As illustrated in FIG. 6, pressing the power source switch 205 by the user in the power off state causes the image forming apparatus 200 to transition to the standby state.

The sleep state is a state where the RAM 302 storing the program being activated is energized and power is supplied to portions required for the image forming apparatus 200 to return from the sleep state. Because the program being activated is stored in the RAM 302 in the sleep state, the image forming apparatus 200 can return to the sleep state more quickly than in a case of returning from the power off state to the standby state, where the program needs to be activated.

As illustrated in FIG. 7B, in the sleep state, the relay 404 is turned off but the relay 405 is turned on. In the sleep state, power is supplied from the first power source unit 402 to the power source control unit 206, the control unit 201, and the printer control unit 203. In the sleep state, power is not supplied from the second power source unit 403 to the printer unit 204.

In the sleep state, the control unit 201 transitions to a power saving mode. In the power saving mode, the supply of power to the image processing unit 306 of the control unit 201 is stopped and the RAM 302 transitions to a self-refresh mode. When the control unit 201 is in the power saving mode, a physical layer (PHY) of the communication I/F 304 is in a state capable of receiving a packet, but the supply of power to a media access control (MAC) is stopped.

As illustrated in FIG. 6, if a factor for return from sleep is detected in the sleep state, the CPU 301 reads the contents of operation from the RAM 302 and the image forming apparatus 200 transitions to the standby state. The factor for return from sleep includes the operation of the operation unit 202 by the user and reception of a job from the client PC 100. In the sleep state, pressing the power source switch 205 by the user causes the image forming apparatus 200 to transition to the power off state. More specifically, in the present exemplary embodiment, pressing the power source switch 205 by the user in the sleep state changes a logic value of a signal input to the power source control unit 206. The power source control unit 206 notifies the CPU 311 that the logic value of the signal has been changed. The notified CPU 311 stores information indicating that the power source switch 205 has been pressed in the printer RAM 312. If the information is stored in the printer RAM 312, the control unit 201 requests the power source control unit 206 to turn off the power source. The power source control unit 206 requested to turn off the power source turns off the relay 405 to bring the image forming apparatus 200 into the power off state. The control unit 201 may execute shutdown processing (such as ending of an application) of the image forming apparatus 200 before the relay 405 is turned off. If the control unit 201 receives a request for updating the firmware in the sleep state, the image forming apparatus 200 transitions to the firmware update state.

The firmware update state is a state to which the image forming apparatus 200 transitions in a case where the control unit 201 updates the firmware.

As illustrated in FIG. 7C, in the firmware update state, the relay 404 is turned off, but the relay 405 is turned on. In the firmware update state, power is supplied from the first power source unit 402 to the power source control unit 206, the control unit 201, and the printer control unit 203. In the firmware update state, power is not supplied from the second power source unit 403 to the printer unit 204.

In the firmware update state, the control unit 201 transitions to a normal mode. In the normal mode, power is supplied to the entire control unit 201. At this point, the self-refresh mode of the RAM 302 is released. In a case where the control unit 201 is in the normal mode, power is supplied also to the MAC of the communication I/F 304.

As illustrated in FIG. 6, in the firmware update state according to the present exemplary embodiment, even if the power source switch 205 has been pressed, the power state of the image forming apparatus 200 is not changed. When the update of the firmware is completed, the image forming apparatus 200 performs a reboot.

The standby state is a state to which the image apparatus 200 transitions when a job such as a print job is completed.

As illustrated in FIG. 7D, in the standby state, the relays 404 and 405 are turned on. In the standby state, power is supplied from the first power source unit 402 to the power source control unit 206, the control unit 201, and the printer control unit 203. In the standby state, power is supplied from the second power source unit 403 to the printer unit 204.

As illustrated in FIG. 6, the image forming apparatus 200 transitions to the sleep state when a factor for transition to sleep (e.g., time is up in a sleep timer and the client PC 100 issues an instruction for transition to the sleep state) is detected in the standby state. In the standby state, pressing the power source switch 205 by the user causes the power source control unit 206 to turn off the relays 404 and 405 to bring the image forming apparatus 200 into the power off state.

The sleep timer is stopped when the image forming apparatus 200 starts printing and the firmware starts to be updated. The sleep timer is reset when printing is completed or the image forming apparatus 200 transitions to the standby state.

### (Details on the Power Source Control Unit)

The power source control unit 206 is described in detail below. The power source control unit 206 controls the power state of the image forming apparatus 200. The power source control unit 206 is a processor operating according to a power source control program stored in the printer ROM 313. The power source control unit 206 may be a hardware logic circuit. The first power source unit 402 supplies power to the power source control unit 206. A signal whose logic value is changed when the power source switch 205 is pressed is input to the power source control unit 206. The power source control unit 206 controls states (on-state and off-state) of the relays 404 and 405.

The power source control unit 206 in the present exemplary embodiment executes a different operation depending on a power state of the image forming apparatus 200 when the power source switch 205 is pressed.

In a case where the image forming apparatus 200 is in the standby state, the power source control unit 206 turns off the relays 404 and 405 when the power source switch 205 is pressed. This promptly turns off the power source for the image forming apparatus 200. On the other hand, when the power source switch 205 is pressed in a case where the image forming apparatus 200 is in the sleep state, the power source control unit 206 does not promptly turn off the relay 405. Pressing the power source switch 205 causes the printer RAM 312 to store information indicating that the power source switch 205 has been pressed. The information stored in the printer RAM 312 is periodically monitored by the control unit 201. When the control unit 201 determines that the information is stored in the printer RAM 312, the control unit 201 sends a request for turning off the power source to the power source control unit 206 to cause the power source control unit 206 to turn off the relay 405. The power source control unit 206 that has received the request for turning off the power source turns off the relay 405. In a case where the image forming apparatus 200 is in the firmware update state, even if the power source switch 205 is pressed, the power source control unit 206 does not turn off the relay 405. In the firmware update state, the control unit 201 does not send the request for turning off the power source to the power source control unit 206.

### (Firmware Update Processing)

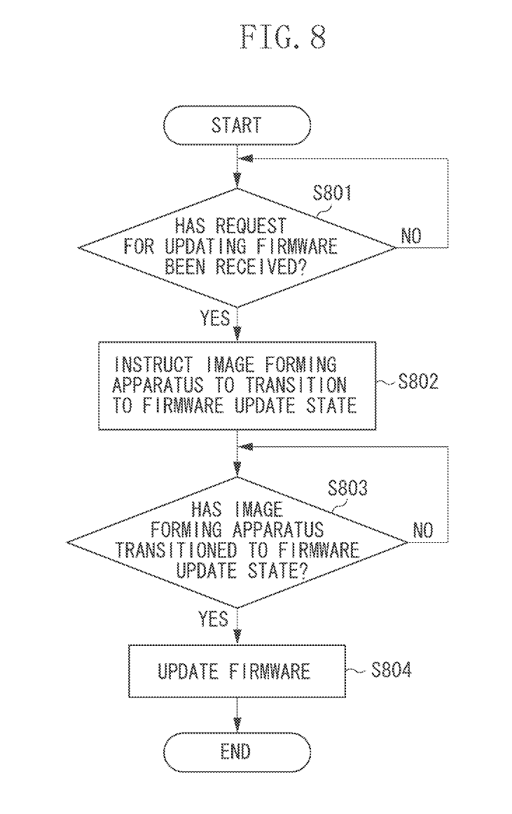

FIG. 8 is a flow chart illustrating processing executed by the control unit 201 in updating the firmware. Each processing in the flow chart in FIG. 8 is executed by the CPU 301 of the control unit 201.

If the communication I/F 304 receives a request for updating the firmware from the client PC 100, the communication I/F 304 notifies the CPU 301 of the request. If the CPU 301 determines that the request for updating the firmware has been made (YES in step S801), in step S802, the CPU 301 performs control so that the image forming apparatus 200 transitions to the firmware update state. More specifically, if the CPU 301 determines that the request for updating the firmware has been made, the CPU 301 transmits a transition instruction to the power source control unit 206 so that the image forming apparatus 200 transitions to the firmware update state. The power source control unit 206 that has received the transition instruction turns off the relay 404 and turns on the relay 405. This causes the image forming apparatus 200 to transition to the firmware update state. If the CPU 301 determines that the image forming apparatus 200 transitions to the firmware update state (YES in step S803), in step S804, the CPU 301 updates the firmware.

### (Processing in the Sleep State or in the Firmware Update State)

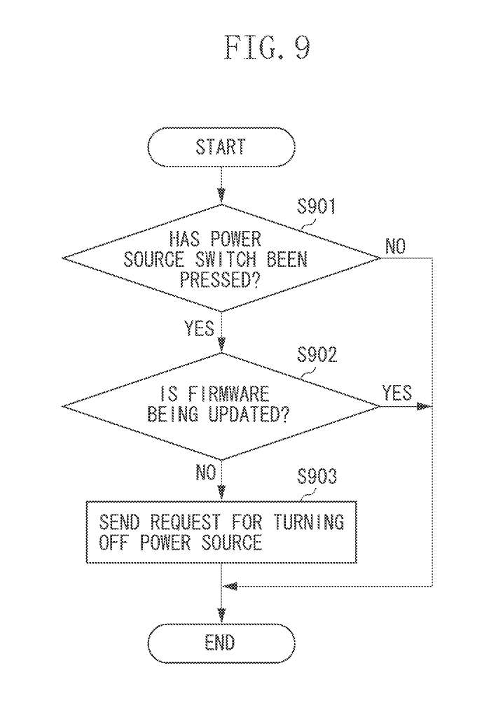

FIG. 9 is a flow chart illustrating processing executed by the CPU 301 in the sleep state or the firmware update state.

The processing illustrated in FIG. 9 is repetitively executed at a predetermined interval while the image forming apparatus 200 is in the sleep state or the firmware update state.

In step S901, the CPU 301 inquires of the printer control unit 203 about contents of the printer RAM 312 to determine whether the power source switch 205 has been pressed. As a result of the inquiry, if the printer RAM 312 stores the information indicating that the power source switch 205 has been pressed (YES in step S901), in step S902, the CPU 301 determines whether the firmware is being updated. If the firmware is not being updated (NO in step S902), in step S903, the CPU 301sends a request for turning off the power source to the power source control unit 206. The power source control unit 206 that has received the request for turning off the power source turns off the relay 405 and brings the image forming apparatus 200 into the power off state. In the present exemplary embodiment, if the firmware is being updated (YES in step S902), the CPU 301 does not send the request for turning off the power source to the power source control unit 206. When the update of the firmware is completed, the CPU 301 performs a reboot. More specifically, the CPU 301 resets each unit of the image forming apparatus 200 and performs the reboot of the image forming apparatus 200.

### (Processing in the Power Source Control Unit)

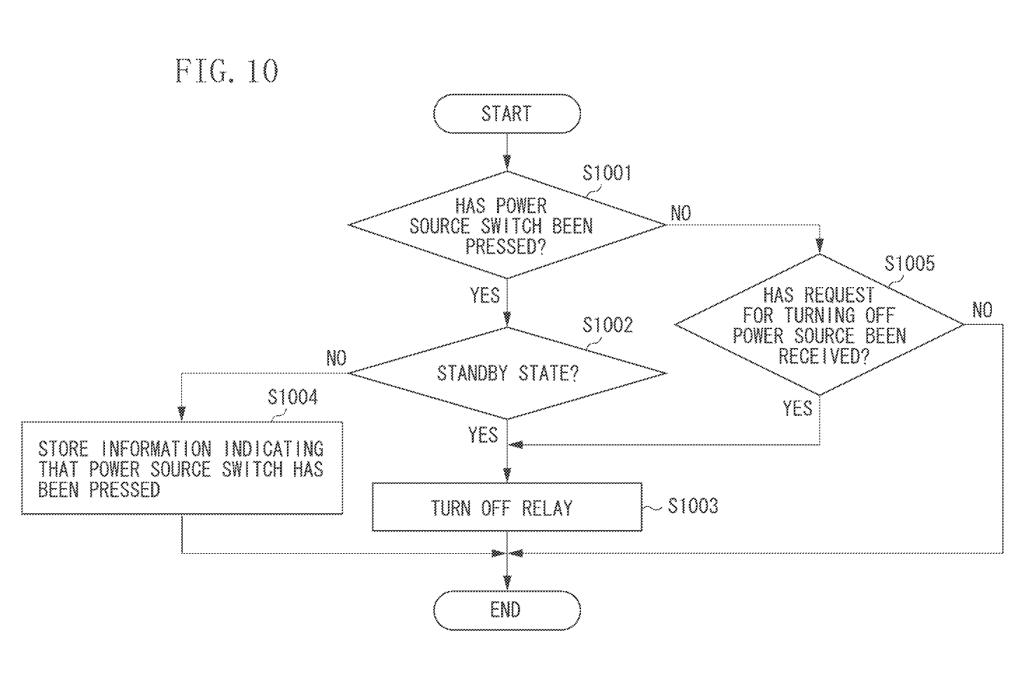

FIG. 10 is a flow chart illustrating processing executed by the power source control unit 206.

In step S1001, the power source control unit 206 determines whether the power source switch 205 has been pressed. If the power source switch 205 has been pressed (YES in step S1001), in step S1002, the power source control unit 206 determines whether the image forming apparatus 200 is in the standby state. If the image forming apparatus 200 is in the standby state (YES in step S1002), in step S1003, the power source control unit 206 turns off the relays 404 and 405. This brings the image forming apparatus 200 into the power off state.

On the other hand, if the image forming apparatus 200 is not in the standby state but in the sleep state or in the firmware update state (NO in step S1002), in step S1004, the power source control unit 206 causes the printer RAM 312 to store the information indicating that the power source switch 205 has been pressed.

If the power source switch 205 has not been pressed (NO in step S1001), in step S1005, the power source control unit 206 determines whether a request for turning off the power source transmitted from the control unit 201 has been received. If the request for turning off the power source has been received (YES in step 1005), the power source control unit 206 turns off the relays 404 and 405. This brings the image forming apparatus 200 into the power off state.

Thus, the power source control unit 206 turns off the relay 405 on the condition that the power source switch 205 has been pressed or the request for turning off the power source has been received from the control unit 201.

### Effects of the Present Exemplary Embodiment

Thus, in the present exemplary embodiment, if the request for updating the firmware has been received from the client PC 100, the image forming apparatus 200 transitions to the firmware update state. Even if the power source switch 205 has been pressed in the firmware update state, the image forming apparatus 200 does not transition to the power off state unless the control unit 201 sends the request for turning off the power source to the power source control unit 206. This can prevent power supply to the control unit 201 updating the firmware from being stopped while the firmware is being updated.

In the present exemplary embodiment, an example is described in which the image forming apparatus 200 transitions to the firmware update state while the firmware is being updated. However, the image forming apparatus 200 may transition to the sleep state while the firmware is being updated. Although the control unit 201 transitions to the power saving mode in the sleep state, power supply to the CPU 301 is maintained, so that the processing according to the flow chart illustrated in FIG. 9 can be performed.

In the present exemplary embodiment, an example is described in which power supply to the control unit 201 is stopped. In another exemplary embodiment, the control unit 201 may be brought into a reset state.

The functions illustrated in the flow charts in the present exemplary embodiment can also be realized by executing software (programs) acquired via a network or various storage media using a processing devices (a CPU or a processor) of a personal computer.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-244123 filed Nov. 26, 2013, which is hereby incorporated by reference herein in its entirety.

What is claimed is:

1. An image forming apparatus operating at least in a first power state and a second power state, comprising:
a control unit configured to update firmware; and
a power source control unit configured to stop supplying power to the control unit in the first power state on condition that a power source switch is operated by a user, and stop supplying power to the control unit in the second power state on condition that the power source control unit receives a request from the control unit for turning off a power source,
wherein the control unit performs control so that the image forming apparatus transitions to the second power state when the control unit updates the firmware.

2. The image forming apparatus according to claim 1, wherein the control unit updates the firmware after the image forming apparatus transitions to the second power state.

3. The image forming apparatus according to claim 1, wherein the control unit does not send the request for turning off the power source to the power source control unit while updating the firmware.

4. The image forming apparatus according to claim 1, wherein power supply to a printing unit configured to print an image on a sheet is stopped in the second power state.

5. The image forming apparatus according to claim 1, further comprising a storage unit configured to store information indicating that the power source switch is pressed,
wherein the control unit sends the request for turning off the power source to the power source control unit in a case where the information is stored in the storage unit.

6. A method for controlling an image forming apparatus operable at least in a first power state and a second power state and including a control unit configured to update firmware, the method comprising:
stopping supply of power to the control unit in the first power state on condition that a power source switch is operated by a user; and
stopping supply of power to the control unit in the second power state on condition that a request for turning off a power source sent from the control unit is received,
wherein the control unit performs control so that the image forming apparatus transitions to the second power state when the control unit updates the firmware.

7. A computer-readable storage medium storing computer executable instructions for causing an image forming apparatus to execute a method, the method comprising:
stopping supply of power to the control unit in the first power state on condition that a power source switch is operated by a user; and
stopping supply of power to the control unit in the second power state on condition that a request for turning off a power source sent from the control unit is received,
wherein the control unit performs control so that the image forming apparatus transitions to the second power state when the control unit updates the firmware.
